(19) United States
(12) Patent Application Publication
(10) Pub. No.: US 2012/0288844 A1
(43) Pub. Date: Nov. 15, 2012

(54) REVERSE MULTIPLE-CHOICE METHOD FOR KNOWLEDGE ENGINEERING AND EXPERT SYSTEM IMPLEMENTATION

(76) Inventor: Indu Anand, Chelmsford, MA (US)

(21) Appl. No.: 13/457,440

(22) Filed: Apr. 26, 2012

Related U.S. Application Data
(63) Continuation-in-part of application No. 11/350,266, filed on Feb. 7, 2006, now Pat. No. 8,195,085.
Application No. 11/350,266 is a continuation-in-part of application No. 09/951,132, filed on Sep. 12, 2001, now Pat. No. 7,033,182.
(60) Provisional application No. 60/232,110, filed on Sep. 11, 2000.

(51) Int. Cl. G09B 7/00

(52) U.S. Cl. 434/353

(57) ABSTRACT

A system and method of communication based on the Reverse Multiple-Choice Method of teaching and testing is disclosed where at least one communicant is a machine. The method is applicable for training a machine for knowledge engineering and artificial intelligence oriented applications, as well as for a trained machine to assist a human being engaged in the activity of teaching or testing.

### CROSS-REFERENCE TO RELATED APPLICATIONS

This application is a continuation-in-part of U.S. patent application Ser. No. 11/350,266, filed Feb. 7, 2006, which claims the benefit of U.S. patent application Ser. No. 09/951,132, filed Sep. 12, 2001, now U.S. Pat. No. 7,033,182, which claims the benefit of U.S. Provisional Patent Application Ser. No. 60/232,110, filed Sep. 11, 2000.

The entire contents of application Ser. No. 11/350,266, application Ser. No. 09/951,132 and Provisional Application Ser. No. 60/232,110 are hereby incorporated by reference.

### FIELD OF THE INVENTION

The present invention relates generally to machine learning and the development and use of query-based expert systems. More specifically it extends a multiple-choice based method of generating educational and testing materials to knowledge engineering.

### BACKGROUND OF THE INVENTION

Multiple-choice questions are a common way of testing students in a variety of subject areas, particularly in examinations taken by large numbers of students. In its most commonly used form, a multiple-choice question comprises three identifiable sections: a section containing a set of facts to be presumed (for instance, a narrative, a short story, a poem, an expression, an equation, or a geometric figure), an interrogative sentence (sometimes known as the “call of the question”), and a set of answer choices. A multiple-choice question can also be thought of consisting of two parts—a first part, comprising a set of facts to be presumed and an interrogative sentence, and a second part, comprising a set of answer choices. The first part may be referenced as a “query” herein. The second part, typically contains between three and five answer choices, one of which may be marked as the correct answer, although the number of answer choices may vary below three or above five under appropriate circumstances.

Reverse Multiple-Choice Method (“RMCM”) was introduced in U.S. patent application Ser. No. 09/951,132, now U.S. Pat. No. 7,033,182. A key part of a typical RMCM embodiment requires a student to: (i) methodically examine each answer choice in relation to the question; (ii) identify the key data or information provided in the question that make that answer choice correct or incorrect; and then, (iii) inquire how the given set of facts could be modified to make that particular answer choice the “correct” or “best” answer. The last step is a crucial part of RMCM, and it depends on the identification of the important facts within the query on which the correctness or incorrectness of the answer choice rests. In Reverse Multiple-Choice environment these important facts are termed “Fact Objects.” A fact object is a semantic entity which is often, though not universally, expressed in the syntactic construction of the query and it is meaningful in the context of the query and one or more of the answer choices provided. Thus, for instance, it is possible for the same word to be used in a narrative twice impacting the meaning the first time but not on the second occasion; that word in that scenario would be a fact object (or a segment of a fact object) for an answer choice the first time but not the second time. Similarly, a phrase may be a fact object in the context of one answer choice for a question but not for another answer choice, where that phrase is not relevant to the context depicted in the latter answer choice.

Unlike traditional multiple-choice questions, the wrong or incorrect answer choices in RMCM questions are just as valuable teaching tools as the correct answers. By teaching a student to deconstruct and reassemble a question, as it were, RMCM could train him or her to critically examine a given set of facts, and to recognize their relationship to the key words, phrases, concepts or facts, in order to achieve in-depth understanding of particular subject matter.

The advantages of RMCM are not limited to interactions between human teachers/examiners and students/examinees. The attributes of RMCM may be used effectively when the “student” is a machine, learning to imbibe the “knowledge” of a human expert; or conversely, in a situation where a machine is the expert trainer, for example of a human trainee/student; or when a machine aids a human teacher/examiner as a competent assistant to help fashion the most effective educational materials. Most of these situations require computers to go beyond their traditional, procedural roles of providing support for data management and number-crunching and be available to augment or replace human intelligence with “artificial” intelligence—hence these situations call for “machine learning” in some form or another.

Machines that can “learn” must demonstrate capability to understand the meaning of natural (human) language to an extent. This could require, for example, that given a form of text (such as, a document, message, narrative, or script) the machine be able to parse the text and generate an instantiated follow-up script that would be regarded as conveying the meaning of the original text at an acceptable level. Other ways to demonstrate the understanding might be similar to the following: recall, not as a regurgitated barrage of the inputs, but as an organized presentation of the text content; high performance on a test; augment its lexical knowledge; consult a resource such as a dictionary to interpret a new script; adaptively respond in a coherent manner to new script.

Such machine-based expert systems or “intelligent” systems have the following identifiable components: a knowledge base which represents the compilation of known facts gleaned from several sources (generally external to the system to include “real world” knowledge), possibly including a human expert; an inference engine which includes the rules for operating on the facts either in the knowledge base or new to the system; a database on which the knowledge base and inference engine may operate; and input and output units that allow the system to communicate with a user, in particular to communicate appropriate conclusions in new situations. There may also be interpreter components that explain the reasoning behind the inferences and/or carry out actions based on the conclusions.

Knowledge based methods include: clustering of texts according to “similarity” by compiling frequency vectors of index terms; Latent Semantic Indexing which takes advantage of “closeness” of words in a comparison of texts; adaptive techniques based on relevance feedback; preprocessing of texts by category; syntactic categorization; semantic analysis using “fuzzy” logic; or some combination of similar techniques. The more successful of these techniques involve a variation of two-pass “prediction and correction” routine.

Reverse Multiple-Choice techniques are compatible with these and other similar approaches for developing intelligent machines. RMCM puts the onus of the learning on the expert to generate well-crafted queries, whether the expert in the learning situation is the human or the machine.

As used herein, the terms knowledge systems and expert systems are used interchangeably, as are the terms machine learning, knowledge engineering, natural language processing, artificial intelligence etc. They may include statistical or probabilistic measurement and analysis, either based on fuzzy sets and logic or on “crisp” sets and logic.

### SUMMARY OF THE INVENTION

With suitable adaptation, the “Reverse Multiple-Choice Method” (RMCM) methodology for generation of educational and testing materials may be extended beyond academic teaching and testing. In particular, the key concepts of RMCM, viz., that of “fact object” and that of “changing a query corresponding to an incorrect answer making it a correct answer to the changed query” of a multiple-choice question can be advantageously used in artificial intelligence oriented applications.

One possible application of the extended RMCM methods is in assisted generation of suitable RMCM queries for teaching or testing. Such assistance of the computer may go beyond the simple retrieve and store functions involving databases; it is envisioned as the capacity for analytical dialogue that a “trained” machine with components to “reason” can carry on with a human, combine it with its rich database, and provide new queries for question writing. Indeed, the roles of a human trainer and machine trainee can eventually reverse as the machine acquires sophistication.

The field of expert systems or knowledge engineering is identified in the literature by several names—its key characteristics being the existence within the system of the following identifiable components: a knowledge base which represents the compilation of known facts gleaned from several sources (generally external to the system to include “real world” knowledge), possibly including a human expert; an inference engine which includes the rules for operating on the facts either in the knowledge base or new to the system; a database on which the knowledge base and inference engine may operate, in particular to draw and communicate appropriate conclusions in new situations; and, input and output units that allow the system to communicate with a user. There may also be interpreter components that explain the reasoning behind the inferences and/or carry out actions based on the conclusions. Most of these functions of the system depend on the machine's “learning” the facts and the rules from a “dialogue” between the machine and a human expert. In one form or another, this relies on presenting or finding answers to queries presented. As described below herein, RMCM can contribute to most of the functions of machine based expert systems.

“Reverse Multiple-Choice Method” (RMCM), introduced and defined in U.S. patent application Ser. No. 09/951,132, is a method of developing educational and testing products or materials, by utilizing multiple-choice questions. RMCM represents a reversal of perspective from traditional multiple-choice approach. Starting with a given set of facts to be presumed, the method may require one to examine each answer choice, and inquire how the set of facts to be presumed could be modified to make that answer choice the “correct” or “best” answer choice. If a given answer choice is already correct, no modification is needed. If a given answer choice is not correct, various modifications may be employed, including changing some of the words or phrases, or other symbols or objects within the set of facts to be presumed.

Whereas the currently available educational products based on the multiple-choice format regard the set of facts to be presumed as “fixed,” and “variably” examine the answer choices to pick the correct one, RMCM temporarily “fixes” an answer choice as the correct answer and “varies” the facts of the question to accommodate that assumption.

Through a process of leading the student to deconstruct and reassemble a question, RMCM provides a method for using the multiple-choice format in focusing the students on the art of closely reading the fact pattern, critically evaluating the answer choices, and learning to recognize the critical pieces of information in the fact pattern on which the answer choices turn. The skills learnt through this process, with or without the assistance of machine or human tutor, underlie the strength of RMCM as a self-study tool. Tests based on Reverse Multiple-Choice Method may be able to measure the extent to which the examinees have learnt these critical skills.

The measure of the test-takers' ability to recognize critical pieces of information in the given fact pattern vis-a-vis the possible answer choices is generally the central goal of an educational testing regime as reliable predictor of their knowledge and understanding.

The same paradigms for learning and applying the knowledge to new situations is the goal as well for machines which are either expected to function without human supervision or to assist the human operators in tasks not amenable to preset, procedural computations.

To elaborate, consider, for example, one illustrative embodiment of RMCM for educational testing which comprises the steps of: (a) providing one or more multiple-choice questions, each question comprising a query and a plurality of answer choices, wherein said plurality of answer choices comprises one correct answer and one or more incorrect answers; (b) prompting the examinee to select an answer choice as the correct answer; (c) maintaining a record of the examinee's selection in step (b); (d) assigning credit for the examinee's selection of an answer in step (b) according to a preset formula; (e) prompting the examinee to select at least one of said plurality of answer choices not selected in step (b); (f) prompting the examinee to provide a follow-up query to which the answer choice selected in step (e) is a correct answer; (g) maintaining a record of the examinee's answer in step (e); (h) assigning credit for the examinee's selection of an answer in step (e) according to a preset formula; (i) combining the credit generated in steps (d) and (h) into a score for the question according to a preset formula; (j) evaluating the score, e.g., against a preset standard.

This very method may be adapted to train a machine by suitably framing the questions and judiciously compiling the answers, both from the human trainer and from the machine. In this adaptation step (b) may be omitted, and any of the steps (d), (h), (i) and (j) related to assigning credit may be suitably modified. One possible modification may be to associate weights in accordance with statistical or probabilistic models corresponding to the given answer choices or to the facts on which the answers turn (fact objects).

Furthermore, steps of the same core method may be adapted in order for the machine to assist a human, for instance, by providing decision support. For example, the “trained” machine may engage a human operator or actor in a dialogue to understand, analyze and evaluate a newly presented situation, and then generate a short list of appropriate conclusions.

With its step of modifying a query as needed, RMCM provides a concrete mechanism for using and correcting errors and misconceptions in communication; that mechanism can be used to similarly eliminate the errors in communication between humans and machines when suitably adapted.

Training or machine learning is an essential requirement for a functioning expert system, whether the machine assists a human actor or operates autonomously. However, bottlenecks generally remain in knowledge base acquisition. RMCM methodology can be used to ensure that machine learning or training is reliable: as shown in Detailed Description, the method can contribute to the development of robust knowledge base and sound reasoning, and improve the art of expert system development.

### BRIEF DESCRIPTION OF DRAWINGS

FIG. 1 provides an illustration of RMCM in a knowledge acquisition application.

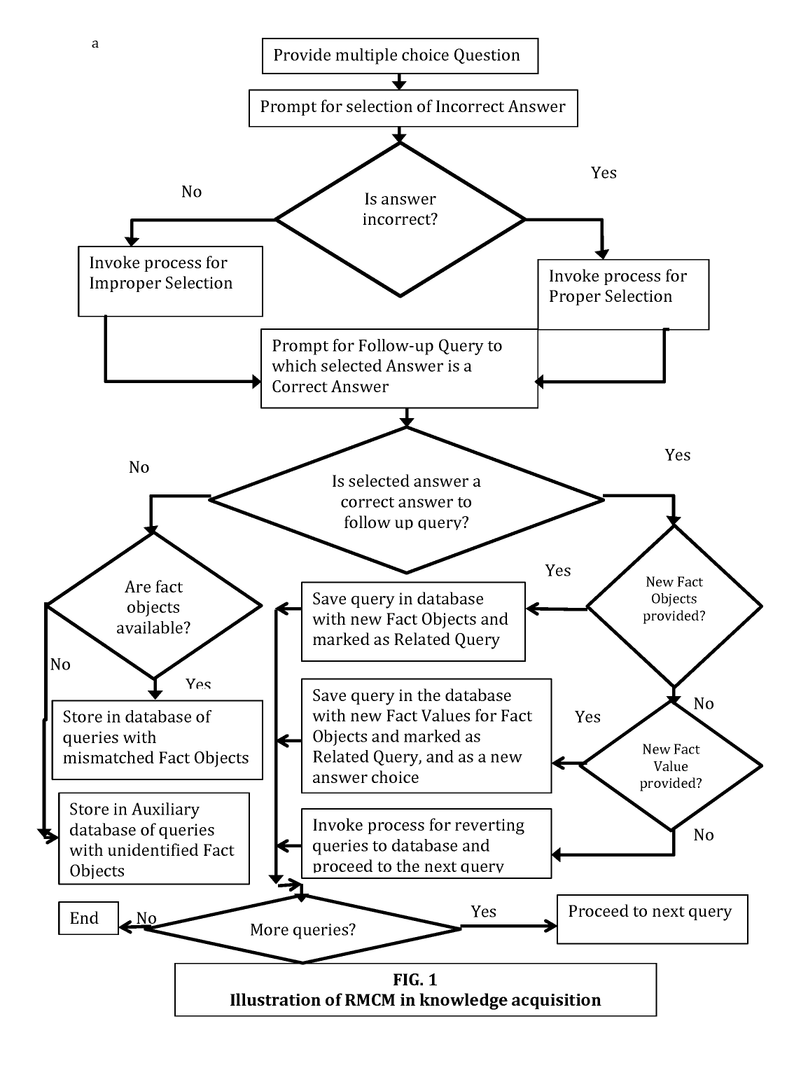

### DETAILED DESCRIPTION

Multiple-choice format for questioning and answering has been used round the globe for academic testing for many decades. In spite of the drawbacks of the format, well-recognized in the educational testing industry, multiple-choice questions remain a common way of testing students in a variety of subject areas, particularly in examinations taken by large numbers of students.

In its most commonly used form, a multiple-choice question comprises three identifiable sections: a section containing a set of facts to be presumed (for instance, a narrative, a short story, a poem, an expression, an equation, or a geometric figure), an interrogative sentence (sometimes known as the “call of the question”), and a set of answer choices. The number of answer choices typically range between two (as in true/false) to five, and there usually is only one correct (or best) answer out of the multiple provided answers.

Although the advantages such as the uniformity of administering and the ease of grading multiple-choice tests are universally recognized, there are other not-frequently-cited, advantages of this user-friendly format. Those inherent and exceptional advantages make this format suitable as well for several non-academic testing applications, such as, applications involving interaction with computer.

The application environments where “Q & A” are fundamental are not limited to the testing of students. The fields such as machine learning, expert systems, knowledge engineering, artificial intelligence and decision support systems etc. all involve a discourse between the “Transferor” and the “Transferee” of knowledge; this transfer of information necessitates a dialogue which can be carried out with clarity in the form of questioning and answering. Furthermore, the roles of questioner and answerer in these applications may alternate between the transferor and the transferee of information. Multiple-choice format brings a unique set of advantages to these non-academic situations.

A well-constructed multiple-choice question is an incisive evaluation tool that requires thought and analysis for the selection of the correct answer out of the various “confounding” answer choices. To the extent that an answer choice can be rejected on cursory inspection, it represents a “lost” opportunity for discrimination and evaluation. On the other hand, if due to a “small” difference in the narrative or the call of the question, correct and incorrect answers trade places, then the “evaluative” value of the question is higher.

In a well-constructed multiple-choice question with k answer choices, the questioner may delve deeper into a topic than in a set of k unrelated questions, since the k answer choices all relate to the same narrative. This allows for the subject matter of the question to be potentially viewed and reviewed from k perspectives. That is akin to locating a data point with k degrees of freedom.

Traditional multiple-choice method of questioning, asking only for the correct answer, discards most of that dimensional freedom. Reverse Multiple-Choice Method, however, exploits the power of the incorrect answers and all k degrees of freedom. Although certain traditional multiple-choice questions may allow for a comparable level of evaluative depth by suitable follow-up questions, RMCM does more than provide for a native structure to enable appropriate clustering of such questions; RMCM's flexible format admits short, structured write-in answers by students. This distinction of RMCM from standard multiple-choice questions can prove more important in a dialogue with a machine than in examining a human student.

By asking the answerer to construct new queries corresponding to the incorrect answers, it is possible to generate Q & A families or clusters that can impart “real world” knowledge, similar in a way to the manner in which a baby acquires real world knowledge by repeatedly asking questions.

On the other hand, in a reverse multiple-choice format the many degrees of freedom are resolved by requiring the answer choices themselves to limit the lexical universe of the question in a way: the reason an answer choice is either correct or incorrect must depend on an identifiable part of the question, whether an explicit segment of the narrative or an implicit requirement inherent in the query string.

This property of multiple-choice questions makes possible the identification of the “key” concepts therein. Identification of the key concepts in a query string is precisely the objective of machine learning. Reverse Multiple-Choice Method as used in the present invention provides a method of quite naturally arriving at the key concepts by seeking “Fact Objects” (FO's) corresponding to each answer choice.

For further discussion, it may be convenient to divide a multiple-choice question into two parts. The first part comprises a set of facts to be presumed and an interrogative sentence. The first part may also be termed a “query.” As used herein, the terms “first part,” “First_Part” and “query” shall be synonymous, unless otherwise noted. A second part of a question comprises a set of answer choices. As used herein, “second part” and “Second_Part” shall be synonymous, unless otherwise noted. (In addition to the definition above, it may be convenient to think of the first part of a question as comprising the portion of a question not included in its second part.) A correct answer (or “Correct_Answer”) is the answer choice that will or would be graded on a test as the “correct” or “best” answer choice to a given query.

A first part of a question typically comprises one or more fact objects (or “Fact_Objects”). A fact object is defined to include any object, word, element, number, operator symbol, phrase, or a group of words, elements, numbers, operators, symbols, or other objects, or any other type of entity capable of holding information. A fact object typically denotes a fact, datum or piece of information in the first part of a multiple-choice question that may be considered when interpreting the answer choices or choosing an answer choice to the question. For instance, in the example discussed above of the box having sides of 1 foot, 2 feet and 3 feet, the length of each side may be considered a fact object. In a short story, each piece of information presented (which can be thought of as a word or group of words) may be considered a fact object. In a question on an art history exam, there may be a single fact object—the piece of artwork presented—and the interrogative sentence may ask the answerer to consider answer choices relating to the work or its creator to select the “correct” answer choice.

In one embodiment, where a fact object is a phrase or a group of words, elements, numbers, operators, symbols, or other objects or entities, the whole of such phrase or group—but no part less than the whole—of such phrase or group, denotes the particular fact, datum or piece of information contained in or conveyed by the fact object. The significance of a fact object may derive partly or primarily from the context of (including its placement within) the query and the set of answer choices of a particular multiple-choice question.

Ideally, as mentioned above, in a carefully constructed multiple-choice question, every answer choice will utilize this contextual connection between the critical information content of the fact object or fact objects in the given query and the answer choice. Generally, an embodiment with minor variations can be used either for purposes of study or review, or for testing. For example, a student may be shown the fact objects corresponding to different answer choices to a question in side by side comparisons, whereas a test-taker might be called upon to match the fact objects (or their values) from a list to different answer choices in comparative displays.

A Method of Training a Machine by a Human Expert

The following is an illustrative session of RMCM based training dialogue between Human Expert, H, and Machine expert-under-construction, M, wherein a Fact Value (FV) is an instantiation of a Fact Object (FO), case defines a question and a dialogue below is expected to loop iteratively as many times as decided by H:
(i) User U defines a case. (U may be =H)
(ii) H creates or displays a previously created multiple-choice question Q based on case narrative—Answer Choices (ACs), Fact Objects (FOs), Fact Values (FVs)
(iii) Q is stored in database if a new question
(iv) U asks M to “scan” question
(v) U asks M for an answer
(vi) M encounters a FO, recalls Q
(vii) M matches FOs sequentially
(viii) IF a match, M matches FVs sequentially
   a. IF an FV match, M produces for U an answer choice
   b. ELSE M requests RMCM answer “correction” from H, records FV(s) for correction
   c. M compares query created in step (ii) with “corrected” query
   d. M asks H if corrected query should be saved as new answer choice alternative
      i. If yes, M saves corrected query as new answer choice alternative
      ii. If no, M saves corrected query as new related case
(ix) IF not an FO match,
   a. M requests RMCM answer “correction” from H, records FO(s) for correction
   b. M compares query created in step (ii) with “corrected” query
   c. M saves corrected query as related new case, if at least one FO match
   d. Else, M saves corrected query as unrelated new case.

Additionally,
(A) System may compute and assign probabilities of case scenarios via FV and FO probabilities
(B) M may be refined by assigning and incorporating probabilities of case scenarios
(C) The roles of H and M are interchangeable;
(D) Either H or M may also be the user U
(E) For each question in the database there are: Query+{AC, FOs, FVs} where AC stands for answer choice, FO for fact object and FV for fact value; each FO has a truth value (T or F) corresponding to each AC; each FO that has the truth value T (relevant) for the AC has an associated FV; each FO with truth value F has no FV associated with it
(F) When M gets an incorrect AC, M records that fact in database as well: Query+AC˜, where AC˜ is the incorrect answer choice
(G) When M produces an incorrect AC as answer, rejected by H, M records that fact as well as Query+AC˜
(H) When H produces an incorrect AC as answer, rejected by M, M records that fact as well as Query+AC˜
(I) When new Answer is presented, M matches it against all ACs and against all AC˜s to present or generate an answer
(J) When new query presented, M matches query against all stored queries to present or generate an answer

Other variations of this method of training based on the RMCM methodology are contemplated to be within the scope of this invention. For example, the training of the machine may be conducted by a group of experts, including humans and other machines with appropriate expertise.

Such sessions used sequentially will generate the Knowledge Base, made up of clusters or families of questions, such that questions within a cluster may be related.

The organization of the knowledge base as related clusters is useful when a new set of conditionals are presented to the machine.

The algorithms of artificial intelligence/expert systems typically ask the machine to return an answer by “pruning the logic tree” that the machine has constructed from the training.

The RMCM based method outlined above, includes graph-theoretic components and does not entirely depend on the tree structure. This approach ensures that all related conditionals are available for consideration and that the logic tree is not pruned prematurely losing a branch of analysis that might have proved useful.

RMCM may generate domain-aware query clusters that are generally not available by other methods generally used in the machine learning environments. In many machine learning applications one is faced with a high volume of information necessitating the pruning of some branches to analyze the most promising line of reasoning. If it becomes apparent that the line of reasoning being followed is not the most promising one then it becomes necessary to follow the backward chain of reasoning. However, this method of forward and backward can be inefficient if the error in reasoning is uncovered far down the stream.

Other clustering methods have been proposed in the literature, but RMCM has the potential as a flexible, general purpose method of clustering that minimizes the need for backward chaining. The reason for this is that RMCM does not depend on the logical tree structure, but on clusters of queries whose mutual dependency may be related and analyzed via graph-theoretic considerations.

In an expert system implementing a medical diagnoses, for example, the method of this invention can make the difference between right or wrong diagnosis.

Consider the following example of medical diagnosis by Julie Herzner and Miriam Kubiska (1992):

Under the “IF-THEN” inference strategy—
IF forced volume capacity is high (0.625)

(high/low/medium)

AND Bronchoscopy results are positive (0.250)

(positive/negative/inconclusive)

AND local symptoms are present (0.125)

(present/partial/absent)

THEN surgery is probably necessary
IF Metastasis is present (0.500)

(present/absent/unknown)

OR Contraindications to surgery exist (0.500)

(yes/No)

THEN surgery is probably not appropriate.

This example has been reproduced here with the potential (RMCM) Fact Objects identified in bold and underlined, and with the corresponding Fact Values indicated in parentheses underneath.

In a corresponding RMCM approach, the THEN result will not be arrived at immediately. An RMCM compliant engine will expand its horizon and consider the family of related queries with other fact values before pruning the branches of the tree and arriving at a conclusion. In situations where the consequences of premature pruning can be enormous, such as in medical decision making, RMCM approach of establishing and considering expanded options can be extremely useful, even at the expense of some extra time.

It is noteworthy that the usual approaches to expert/knowledge system development do not have widely applicable algorithms to recapture the logical branches once they are pruned.

Similar considerations will apply to Herzner and Kubiska's version of the example below with a slightly different inference rules:

### If-Then-Unless

IF forced volume capacity is high
AND Bronchoscopy results are positive
AND local symptoms are present
THEN Surgery is probably appropriate
UNLESS Metastasis is present
OR Contraindications to surgery exist

A Computer-Aided Method of Developing RMCM Based Materials for Education or Testing

It is anticipated that a computerized machine that has been trained to recognize the relationship between the questions and answers in a particular subject matter will acquire the capability to suggest new queries to the human examiner by intelligently searching its database of queries.

An “expert” machine may eventually also “write” queries for possible acceptance by a human examiner. The methodology for the machine to write such queries will often rely on the clustering mechanisms built into the RMCM system.

Having now described a few illustrative embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method of interacting with a computerized machine comprising the steps of: (a) providing one or more multiple-choice questions, each question comprising a query and a plurality of answer choices, wherein said plurality of answer choices comprises one correct answer and one or more incorrect answers; and (b) for at least one of said one or more incorrect answers, prompting said machine to produce a follow-up query to which said at least one incorrect answer is a correct answer.

2. A method of interacting with a computerized machine comprising the steps of: (a) providing by said machine one or more multiple-choice questions, each question comprising a query and a plurality of answer choices, wherein said plurality of answer choices comprises one correct answer and one or more incorrect answers; and (b) for at least one of said one or more incorrect answers producing a follow-up query to which said at least one incorrect answer is a correct answer.

3. The method of claim 1 or claim 2, wherein said follow-up query is a modification of said query.

4. The method of claim 1 or claim 2, wherein said at least one of said one or more incorrect answers is all of said incorrect answers.

5. A method of interaction between two or more communicants comprising the steps of: (a) providing by one communicant one or more multiple-choice questions, each question comprising a query and a plurality of answer choices, wherein said plurality of answer choices comprises one correct answer and one or more incorrect answers; (b) prompting another communicant to select one of said incorrect answers; and (c) prompting said another communicant to produce a follow-up query to which said incorrect answer choice is a correct answer, wherein one or more of the communicants is a machine.

6. The method of claim 5, wherein step (c) comprises prompting said another communicant to modify fact objects in said query to produce said follow-up query.

7. The method of claim 5, wherein step (c) comprises prompting said another communicant to choose fact objects from a list to modify in producing said follow-up query.

8. The method of claim 7, further comprising the step of: (d) repeating step (c) such that said another communicant is prompted to produce a different follow-up query to which said answer is a correct answer.

9. A method of interaction between two or more communicants comprising the steps of: (a) providing by one communicant one or more multiple-choice questions, each question comprising a query and a plurality of answer choices, wherein said plurality of answer choices comprises one correct answer and one or more incorrect answers; (b) providing a list of fact objects present in said query; and (c) prompting said another communicant to identify which fact objects from said list must be changed in said query for one of said one or more incorrect answers to become a correct answer.

10. The method of claim 9, further comprising the step of: (d) repeating step (c) for each of said one or more incorrect answers.

11. A program stored on a computer-readable medium which, when executed, performs the steps of: (a) providing one or more multiple-choice questions, each question comprising a query and a plurality of answer choices, wherein said plurality of answer choices comprises one correct answer and one or more incorrect answers; (c) prompting a user to select one of said incorrect answers; (d) providing a follow-up query; (e) prompting said user to determine whether said incorrect answer is a correct answer to said follow-up query, wherein said user is a human being or a machine.

12. The program of claim 11, wherein steps (c), (d) and (e) are repeated for every one of said one or more incorrect answers.
